(19) United States
(12) Patent Application Publication
(10) Pub. No.: US 2011/0073812 A1
(43) Pub. Date: Mar. 31, 2011

(54) METHOD AND DEVICE FOR DE-GASSING A LIQUID-GAS-MIXTURE

(75) Inventor: Hans Negle, Nahe (DE)

(73) Assignee: KONINKLIJKE PHILIPS ELECTRONICS N.V., Eindhoven (NL)

(21) Appl. No.: 12/994,484

(22) PCT Filed: May 27, 2009
(86) PCT No.: PCT/IB09/52224

§ 371 Date: Nov. 24, 2010

(30) Foreign Application Priority Data
Jun. 3, 2008 (EP) 08104237.6

(51) Int. Cl. B01D 19/00; C08J 9/00; H01B 1/12

(52) U.S. Cl. 252/500; 521/50; 95/261; 95/248; 96/196

(57) ABSTRACT

A method and a device (1) for de-gassing a liquid-gas-mixture (3) is proposed. The method comprises: inserting the liquid-gas-mixture (3) into a chamber (5) wherein the chamber (5) is at a reduced gas pressure and arranging the liquid-gas-mixture (3) on a centre region (11) of a surface (13) of a rotating body (15) such that the liquid-gas-mixture (3) is subjected to a centrifugal force. Therein, the surface (13) of the rotating body (15) is adapted such that the liquid-gas-mixture (3) is spread over the surface (13) due to the centrifugal force and finally flows over a radially outward edge region (21) of the surface (13) of the rotating body (15). Due to the occurring centrifugal forces, even highly viscous or thixotropic liquids may be-spread over the rotating surface as a thin layer from which gas incorporated in the liquid can easily and effectively escape. Thus, a rigid foam material having low specific weight and high electrically insulating properties can be produced from the de-gassed liquid comprising e.g. a resin into which microspheres are incorporated.

### FIELD OF THE INVENTION

The present invention relates to a method and a device for de-gassing a liquid-gas-mixture and to a method for preparing a rigid foam material using such de-gassing method. Furthermore, the invention relates to a rigid foam material prepared by the inventive method, a high voltage generator using such rigid foam material and an X-ray system with such a high voltage generator.

### BACKGROUND OF THE INVENTION

New types of electrically insulating housings for high voltage generators of X-ray systems may be made of so-called hybrid material or syntactic foam. WO 03/074598 discloses a method for producing a syntactic rigid foam comprising a plurality of microspheres. The microspheres are implemented into a matrix material enclosing the microspheres. For this purpose, a mixture comprising the liquid matrix material and the microspheres may be mixed within a container. Finally, the matrix material contained between the microspheres may be cured thereby forming a light-weighted, stable rigid foam material.

Due to its highly electrically insulating properties, such foam material can be used for example for isolation purposes within a high voltage generator which can be used for example in X-ray systems. For this purpose, the fluid mixture comprising the liquid matrix material and the microspheres can be filled in a mould for constituting an insulating element to be produced and, this mixture can be cured for example by adding a suitable hardener or by subjecting to elevated temperature conditions for a predetermined period of time.

However, it has been found that the mixture comprising the liquid matrix material and the microspheres may comprise a substantial amount of gas incorporated therein. This may be due to the process of mixing the microspheres into the matrix material. Furthermore, it has been found that the mechanical and/or electrical properties of a foam may be negatively influenced due to such incorporated gas.

Therefore, it may be advantageous to de-gas the liquid mixture comprising the matrix material and the microspheres before curing the matrix material. Herein, the term “de-gassing” may be understood as removing gas, e.g. in the form of microscopic bubbles or voids, from a liquid mixture.

Conventionally, de-gassing may be performed by pouring the liquid mixture onto a surface of a body such that a thin film of liquid mixture is formed on the surface. Thereby, the surface of the liquid mixture can be strongly increased. This effect may be even enhanced by using a body having a textured surface including e.g. so-called raschig rings. Due to the strongly increased surface of such film, the gas incorporated in the liquid mixture may diffuse to a surface and escape from the liquid mixture. The process can be enhanced by performing it under conditions of reduced pressure or vacuum.

However, it has been found that, particularly when liquid mixtures having a high viscosity or thixotropic liquid mixtures are to be de-gassed, the conventional de-gassing method may have drawbacks e.g. in that the de-gassing result may be insufficient or it may take a long time.

### SUMMARY OF THE INVENTION

There may be a need for a method and a device for de-gassing a liquid-gas-mixture and a method for preparing a rigid foam material wherein at least some of the above-described shortcomings of the prior art are at least partly overcome. Particularly, there may be a need for a method and a device for de-gassing a liquid-gas-mixture and a method for preparing a rigid foam material wherein a liquid-gas-mixture having a high viscosity or being thixotropic can be easily and effectively be de-gassed. Furthermore, there may be a need for a rigid foam material prepared by such method, a high voltage generator with such rigid foam material and an X-ray system with such high voltage generator.

These needs may be met by the subject-matter according to one of the independent claims. Advantageous embodiments of the present invention are described in the dependent claims.

According to a first aspect of the present invention, a method for de-gassing a liquid-gas-mixture is proposed. The method comprises: inserting the liquid-gas-mixture into a chamber wherein the chamber is at a reduced gas pressure and arranging the liquid-gas-mixture on a centre region of a surface of a rotating body such that the liquid-gas-mixture is subjected to a centrifugal force. Therein, the surface of the rotating body is adapted such that the liquid-gas-mixture is spread over the surface due to the centrifugal force and finally flows over a radially outward edge region of the surface of the rotating body.

According to a second aspect of the present invention, a device for de-gassing a liquid-gas-mixture is proposed. The device comprises: a chamber which is adapted to be subjected to a reduced pressure; a rotation body arranged within the chamber, the body being adapted to be rotated; and a supplying device adapted for supplying the liquid-gas-mixture to a surface of the rotation body. The surface of the rotation body is adapted such that, when the liquid-gas-mixture is arranged on a centre region of the surface of the rotating rotation body, the liquid-gas-mixture is subjected to a centrifugal force and is spread over the surface due to the centrifugal force and finally flows over a radially outward edge region of the surface of the rotation body.

According to a third aspect of the present invention, a method for preparing a rigid foam material is proposed. The method comprises: providing a liquid matrix material; mixing the liquid matrix material with a plurality of microspheres such that a liquid-gas-mixture comprising the matrix material and the microspheres is generated; and de-gassing the liquid-gas-mixture using the method according to the above first aspect of the invention.

According to a fourth aspect of the present invention, a rigid foam material prepared by a method according to the first aspect of the invention is proposed.

According to a fifth aspect of the present invention, a high voltage generator comprising a rigid foam material according to the fourth aspect of the invention is proposed.

According to a sixth aspect of the present invention, an X-ray system comprising a high voltage generator according to the fifth aspect of the invention is proposed.

A gist of the invention may be seen as being based on the following finding:

For a good de-gassing process of a liquid, one may have to enlarge or spread the liquid as a thin layer over a surface in order to have access to the gas in the liquid on molecular level. In the thin layer, small gas bubbles or even gas molecules can easily move to the layer surface and escape therefrom. However, for highly viscous or thixotropic liquids, such as thick liquids like epoxy resins filled up to e.g. 65 Vol-% with hollow microspheres, the force due to normal gravitation may not be sufficient to spread the liquid over the surface.

The inventor of the present application had the idea to use more than the normal gravitational force to enlarge the surface of the liquid. For this purpose, the liquid may be put into a centrifuge under reduced gas pressure. The liquid may be arranged on a surface of a rotating body. Due to centrifugal forces, the liquid may spread over the surface thereby forming a thin layer. From this thin layer, incorporated gas may easily escape. Finally, the liquid can flow over a radially outward edge or border of the surface of the rotating body and may drop into a container. The liquid accumulated in the container is substantially de-gassed and may be used for further processing such as filling it into a mould and curing it in order to form an electrically insulating foam body.

In the following, further possible features, details and advantages of embodiments of the present invention are mentioned.

The liquid-gas-mixture may be any liquid into which gas is incorporated e.g. in the form of microscopic bubbles or in a chemical or physical binding to the molecules of the liquid. For examples, air bubbles may be introduced into a resin when mixing it with microspheres such that the resulting viscous liquid contains, apart from the microspheres, a high content of air or other gases.

The term “de-gassing” may mean to extract air or gas from the liquid-gas-mixture.

For this purpose, the liquid-gas-mixture may be inserted into a chamber. The interior of the chamber may be at a reduced gas pressure, namely a pressure below atmospheric pressure. Such reduced pressure may also be referred to as a vacuum. Pressure values below 100 hPa, preferably below 10 hPa may be chosen.

Within the chamber, the liquid-gas-mixture is arranged on a centre region of a surface of a rotating body. Therein, the “centre region” may be but is not necessarily the geometric middle of the surface. The centre region shall be defined by the effect achieved namely that the liquid-gas-mixture, when arranged in the centre region on the surface of the rotating body, is subjected to a centrifugal force. The surface of the rotating body is adapted such that the liquid-gas-mixture is spread over the surface due to the centrifugal force. Possible geometries of the rotating body and its surface are described further below. As the centrifugal force may be much stronger than the normal gravitational force, the liquid-gas-mixture may be spread strongly and homogeneously such as to form a very thin layer of e.g. less than 1 mm, preferably less than 400 μm and more preferred less than 100 μm. After having spread over the rotating surface, the liquid may move further to the edge of the surface and may then flow over a radially outward edge region of the surface of the rotating body. It may then drop into a container where it may be accumulated for further processing.

Optionally, the liquid may be re-introduced into the centre region of the surface of the rotating body in order to perform a further iteration of spreading and de-gassing. This process may be repeated several times until a sufficient degree of de-gassing is achieved.

According to an embodiment of the method according to the above first aspect of the invention, in dependence of at least one of a viscosity, an amount and a gas content of the liquid-gas-mixture, at least one of a geometry of the surface of the rotating body, a pressure of gas within the chamber, a temperature within the chamber and a rotational speed of the rotating body are adapted such that, after flowing over the radially outward edge region of the surface of the rotating body, the liquid-gas-mixture is essentially de-gassed.

All the mentioned parameters may influence the formation and thickness of the layer of liquid-gas-mixture thereby influencing the de-gassing process. For example, leaving all other parameters constant, the higher the viscosity of the liquid-gas-mixture, the thicker the layer will be and the slower or less effective the de-gassing process will be. The higher the amount of the liquid-gas-mixture, the thicker the layer will be and the slower or less effective the de-gassing process will be. The higher the gas content of the liquid-gas-mixture, the longer the de-gassing process will take. By decreasing the pressure within the chamber or by increasing the temperature within the chamber, the de-gassing process may be accelerated. By increasing the rotational speed of the rotating body, the centrifugal force may be increased such that the liquid-gas-mixture is spread more and forms a thinner layer which may then enhance the de-gassing process. Finally, by adapting the geometry of the surface of the rotating body, the layer formation of the liquid-gas-mixture can be significantly influenced. Possible geometry parameters may be e.g. a surface orientation with respect to a rotation axis of the rotating body, a surface texture, a radius of the rotating surface, etc. All the above parameter may influence the de-gassing result and, furthermore, will inter-depend on each other.

According to a further embodiment of the method according to the above first aspect of the invention, the liquid-gas-mixture is continuously supplied to the surface of the rotating body. In other words, the liquid-gas-mixture is steadily provided to the centre region of the surface of the rotating body, spread over the surface and finally accumulated after flowing over an outer edge of the surface. All process parameters may be selected such that after this process the liquid is sufficiently de-gassed and can be further processed. Accordingly, a continuous process of supplying liquid-gas-mixture, de-gassing it and further processing it can be established.

According to an embodiment of the device according to the above second aspect of the invention, the rotation body comprises a rotationally symmetric surface. Possible geometries are e.g. a round disc, a cone or truncated cone or a curved bowl. The rotational symmetry allows for a homogeneous spreading of the liquid-gas-mixture upon centrifugation.

According to a further embodiment of the device according to the above second aspect of the invention, the rotation body comprises a surface having a tapering shape in a direction parallel to a rotation axis of the rotation body. In other words, the rotation body is not simply a flat disc arranged perpendicular to a rotation axis around which it is rotated. Instead, a surface of the rotation body may extend at least partly in a direction at an angle, namely not perpendicular, to the rotation axis. For example, the surface of the rotation body may form a tapering cone or part of a cone, the symmetry axis of which may extend parallel to the rotation axis. Such geometry may advantageously support the spreading of the liquid-gas-mixture.

According to a further embodiment of the device according to the above second aspect of the invention, the surface having a tapering shape is an inner, i.e. interior, surface of the rotation body and the supplying device is arranged for supplying the liquid-gas-mixture to the inner surface. Then, upon rotation, the liquid-gas-mixture will tend to flow along this inner surface and effectively spread thereon. However, there is no risk that the centrifugal force becomes too high such that the liquid is centrifuged away. Accordingly, the rotation speed of the rotating body can be freely adapted to the properties and parameters of the liquid to be de-gassed without a risk of excessively increasing over an upper limit where the liquid would delaminate from the surface of the rotating body if it were an exterior surface.

Finally, some details and features of the method for preparing a rigid foam material according to the above third aspect of the present invention will be discussed.

The liquid matrix material may be a material which, under normal preparing conditions, is liquid such that it can be mixed with the microspheres and which, afterwards, can be cured such as to generate a rigid matrix into which the microspheres are embedded. For example, the liquid matrix material can be a resin, e.g. an epoxy or silicon resin, which, e.g. by adding a binder, can be cured. Alternatively, the liquid matrix material can be a polymer which, after mixing with the microspheres, can be cured by polymerization to generate a rigid matrix.

The term “microspheres” should be interpreted in a broad sense herein. The microspheres can be hollow spheres comprising a gas, liquid and/or solid material or may be constituted from such materials and/or further comprising hollow spaces created for example by inflation with a blowing agent contained in the material. The “microspheres” may comprise a spherical shape but, alternatively, may also comprise other hollow shapes. In order to obtain a high packing density of the microspheres within the matrix material, a microspheres mixture comprising large and small microspheres can be used wherein the diameters of the microspheres may be selected such that the space between large microspheres may be occupied by corresponding small microspheres. For applications of rigid foam material for high voltage insulation material, microspheres having a diameter in the range of approximately 5-100 μm have proved particularly suitable. Therein, the large diameter microspheres may have a diameter of between 30 and 100 μm whereas the small diameter microspheres may have diameters in the range between 5 and 30 μm. However, particularly in cases where low specific weight is desired, also microspheres having a larger diameter up e.g. up to 1000 μm may be used.

The microspheres may be produced for example from glass, ceramic or phenolic resin, an acrylonitrile copolymer or any other insulating material such as for example thermoplastic or duroplastic plastic material.

The microspheres may comprise a gas such as for example sulphur hexafluoride (SF₆), isopentane, Nitrogen (N₂), Hydrogen (H₂), sulphur dioxide (SO₂), carbon dioxide (CO₂) or another gas. The gas may be under an elevated or reduced pressure, depending on the size of the microspheres, in order to improve the high voltage capacity and/or the rigidity against exterior pressure. Depending on the application it may be advantageous to replace at least a part of the hollow microspheres by spheres comprising a solid and/or liquid material. Details of the generation of microspheres are known in the art and will not be explained herein.

The binder to be optionally added to the matrix material can be a substance which may initiate or enhance the curing of the liquid matrix material in order to finally form a solid matrix material.

The curing of the mixture comprising the matrix material, the microspheres, and, optionally, the binder may be performed after the mixture has been filled in a corresponding mould representing the geometry of a rigid foam element to be prepared. The curing process may be initiated or supported by providing energy to the mixture for example in the form of exterior heat. Additionally or alternatively, the curing may be initiated or enhanced by provision of additional chemical substances.

Additionally to the above-mentioned substances and materials, further substances can be added to the components forming the rigid foam material. For example, known wetting and dispersing additives may be introduced in order to control the thixotropy and/or viscosity of the material mixture. Furthermore, an adhesion promotor may be added in order to improve the adhesion of the microspheres to the matrix material such that the high voltage stability of the resulting insulating rigid foam material may be further increased. In case of a microsphere made from glass or ceramic, the adhesion to the polymer or resin matrix can be increased by a silanisation with about 0.1 to 0.3%. If the microspheres are made of a plastic, the adhesion to a polymer matrix may be improved by coating the plastic spheres with calcium carbonate.

The rigid foam material prepared by the above-described method in one of its embodiments may have a very low specific weight of e.g. 0.5 g/cm³ and, furthermore, may have very good electrically insulating properties. This may be at least partly due to the possible high content of microspheres within the matrix material and, furthermore, to the advantageous de-gassing properties due to the proposed de-gassing method. Therefore, the resultant rigid foam material can be used as high voltage isolation material for example in a high voltage generator or high voltage power supply unit which then may be used for example in stationary as well as in rotating X-ray systems. For example, before curing, the mixture comprising the liquid matrix material, the microspheres and, optionally, the binder may be used as a moulding material which may be moulded to a structure having recesses into which high voltage components may be accommodated thereby ensuring electrical insulation against their surrounding.

It has to be noted that aspects and embodiments of the invention have been described with reference to different subject-matters. In particular, some embodiments have been described with reference to the method type claims whereas other embodiments have been described with reference to apparatus type claims. However, a person skilled in the art will gather from the above and the following description that, unless other notified, in addition to any combination or features belonging to one type of subject-matter also any combination between features relating to different subject-matters, in particular between features of the apparatus type claims and features of the method type claims, is considered to be disclosed with this application.

### BRIEF DESCRIPTION OF THE DRAWING

Further details, features and advantages of the present invention may be derived from a description of a preferred embodiment as presented in the FIGURE but to which the present invention shall not be limited.

FIG. 1 shows a device for de-gassing of a liquid-gas-mixture according to an exemplary embodiment of the present invention.

The FIGURE is only schematic and not to scale.

### DETAILED DESCRIPTION AF A PREFERRED EMBODIMENT

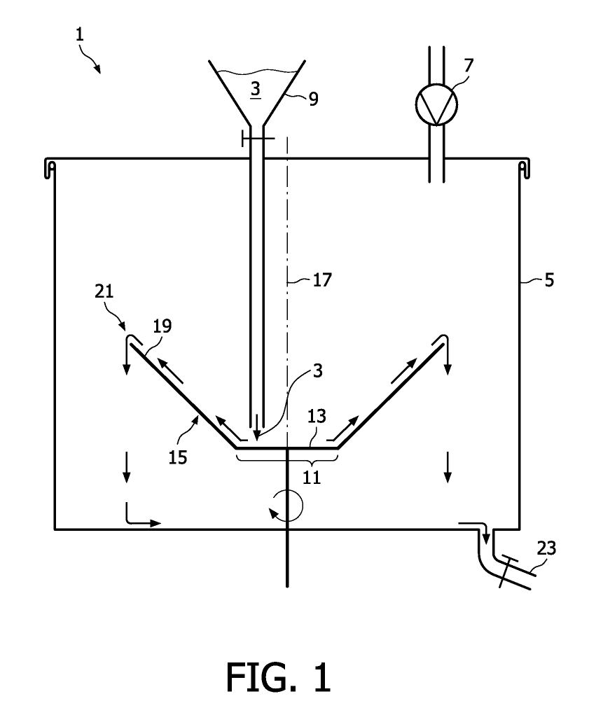

In FIG. 1, a device 1 for de-gassing a liquid-gas-mixture 3 is depicted. The device 1 comprises a chamber 5 the interior of which may be put at a reduced pressure of 5 hPa using a vacuum pump 7. The liquid-gas-mixture 3 may be introduced into the chamber 5 via a supplying device 9. The supplying device 9 may be a simply valve or a dosing pump. The supplying device 9 is arranged such that liquid-gas-mixture 3 supplied to the chamber 5 drops onto a centre region 11 of an inner surface 13 of a rotation body 15.

The rotation body 15 is a truncated cone which is tapered downwardly and which is open at the top. As the rotation body 15 rapidly rotates around a rotation axis 17 coinciding with its symmetry axis, the liquid-gas-mixture 3 will be pressed outwardly by centrifugal forces. The flow of the liquid-gas-mixture 3 is schematically depicted in the FIGURE by arrows. The liquid-gas-mixture 3 will flow and spread along the entire angled inner surface 19 of the cone-shaped rotation body 15 before reaching its radially outer edge 21. There, it will drop onto the bottom of the chamber 5 and finally flow to an outlet 23. The liquid accumulating at the bottom of the chamber 5 is substantially de-gassed which means that the gas originally contained in the liquid is removed to an essential extend, e.g. by more than 90%.

In an alternative embodiment, the chamber 5 may be part of a mixing vessel (not shown) in which components of a liquid such as a resin and a powder comprising microspheres are mixed with each other. The resulting liquid is highly viscous and may be fed directly onto the rotation body 15 for de-gassing. At the end, a well de-gassed compound comprising a liquid matrix material enclosing microspheres will accumulate at the bottom of the chamber 5 and will be ready for further processing such as e.g. moulding and curing to form a highly insulating rigid foam material.

Finally, it should be noted that the term “comprising” does not exclude other elements or steps and the term “a” or “an” does not exclude a plurality of elements. Also elements described in association with different embodiments may be combined. It should also be noted that reference signs in the claims should not be construed as limiting the scope of the claims.

1. A method for de-gassing a liquid-gas-mixture (3), the method comprising:
inserting the liquid-gas-mixture into a chamber wherein the chamber (5) is at a reduced gas pressure;
arranging the liquid-gas-mixture (3) on a centre region (11) of a surface (13) of a rotating body (15) such that the liquid-gas-mixture (3) is subjected to a centrifugal force;
wherein the surface (13) of the rotating body (15) is adapted such that the liquid-gas-mixture (3) is spread over the surface (13) due to the centrifugal force and finally flows over a radially outward edge region (21) of the surface (13) of the rotating body (15).

2. The method of claim 1, wherein, in dependence of at least one of a viscosity, an amount and a gas content of the liquid-gas-mixture, at least one of a geometry of the surface (13) of the rotating body (15), a pressure of gas within the chamber (5), a temperature within the chamber and a rotational speed of the rotating body (15) are adapted such that, after flowing over the radially outward edge region (21) of the surface (13) of the rotating body (15), the liquid-gas-mixture (3) is essentially de-gassed.

3. The method of claim 1, wherein the liquid-gas-mixture (3) is continuously supplied to the surface of the rotating body (15).

4. The method of claim 1, wherein the liquid-gas-mixture is re-introduced on the centre region (11) of the surface (13) of the rotating body (15) in order to perform a further iteration of spreading and de-gassing.

5. The method of claim 4, wherein re-introducing process is repeated several times until a sufficient degree of de-gassing is achieved.

6. A device (1) for de-gassing a liquid-gas-mixture (3), the device comprising:
a chamber (5) which is adapted to be subjected to a reduced pressure;
a rotation body (15) arranged within the chamber (5), the rotation body (5) being adapted to be rotated;
a supplying device (9) adapted for supplying the liquid-gas-mixture (3) to a surface (13) of the rotation body (15);
wherein the surface (13) of the rotation body (15) is adapted such that, when the liquid-gas-mixture (3) is arranged on a centre region (11) of the surface (13) of the rotating rotation body (15), the liquid-gas-mixture (3) is subjected to a centrifugal force and is spread over the surface (13) due to the centrifugal force and finally flows over a radially outward edge region (21) of the surface (13) of the rotation body (15).

7. The device of claim 6, wherein the rotation body (15) comprises a rotationally symmetric surface.

8. The device of claim 6, wherein the rotation body (15) comprises a surface having a tapering shape in a direction parallel to a rotation axis (17) of the rotation body (15).

9. The device of claim 8, wherein the surface (13) having a tapering shape is an inner surface of the rotation body (15) and wherein the supplying device (9) is arranged for supplying the liquid-gas-mixture (3) to the inner surface.

10. A method for preparing a rigid foam material, the method comprising:
providing a liquid matrix material;
mixing the liquid matrix material with a plurality of microspheres such that a liquid-gas-mixture (3) comprising the matrix material and the microspheres is generated;
de-gassing the liquid-gas-mixture (3) using the method according to claim 1.

11. A rigid foam material prepared by a method according to claim 8.

12. A high voltage generator comprising a rigid foam material according to claim 11.

13. An X-ray system comprising a high voltage generator according to claim 12.
